(19) United States
(12) Patent Application Publication
(10) Pub. No.: US 2026/0227902 A1
(43) Pub. Date: Aug. 6, 2026

(54) WEB APPLICATION ASSET MANAGEMENT SYSTEM, METHODS AND DEVICES

(71) Applicant: FIRELINE SCIENCE LLC, Tempe, AZ (US)

(72) Inventors: Collin Arthur Sellman, Tempe, AZ (US); Sean Michael Schaefer, Gilbert, AZ (US); Aaron Tracy Merryman, Glendale, AZ (US)

(73) Assignee: FIRELINE SCIENCE LLC, Tempe, AZ (US)

(21) Appl. No.: 19/042,344

(22) Filed: Jan. 31, 2025

(51) Int. Cl. G06F 3/06; H04L 67/02

(52) U.S. Cl. CPC G06F 3/0604; G06F 3/0652; G06F 3/0655; G06F 3/067; H04L 67/02

(57) ABSTRACT

Systems, devices, and methods are disclosed for web application asset management. The method comprises receiving, by an end user computing device, from a centralized server an asset package, wherein the asset package comprises one or more local assets. The method further comprises collecting, by the end user computing device, end user data associated with a local application. The method comprises receiving, by the centralized server, the end user data from the end user computing device. The method comprises determining, by the centralized server, an end user specific local model based on a predictive classification model, the end user data, and a behavioral cohort, wherein the behavioral cohort reflects one or more end users. The method comprises sending, by the centralized server, the end user specific local model to the end user computing device. The method comprises deleting, by the end user computing device, one or more of the local assets based on the end user specific local model.

### TECHNICAL FIELD

The present disclosure relates generally to methods and systems for managing assets on end user devices utilizing web applications utilizing classification modules.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A progressive web application (PWA) is a type of web application that can temporarily operate offline and without internet connection or connection to other devices. A benefit of using PWAs is they can continue functioning even when the user device loses access to the internet, as the application logic and service workers exist on the client device. Unlike traditional web apps, PWAs may store user assets locally instead of having to request them from an external web server each time a user requires them.

PWAs, however, may have disadvantages, as they often require storing many, large files locally, which may be difficult or impossible given local space limitations. While applications may adopt simple rules like deleting local files that are older than 30 days, these simplistic approaches do not consider the actual desired behavior of end users. Files users intend to access may not be stored locally for offline use. Files that will not be used in the future will take up local space unnecessarily and prevent higher priority files from being cached locally. Ultimately, users may be unable to access assets when they need them.

Accordingly, there is a need for an improved systems and methods management of user assets on user devices, particularly when utilizing PWAs.

### SUMMARY OF THE INVENTION

A method for web application asset management is disclosed herein. In various embodiments, the method may comprise receiving, by an end user computing device, from a centralized server an asset package, wherein the asset package comprises one or more local assets. The method may further comprise collecting, by the end user computing device, an end user data associated with a local application. The method may further comprise receiving, by the centralized server, the end user data from the end user computing device. The method may further comprise determining, by the centralized server, an end user specific local model based on a predictive classification model, the end user data, and a behavioral cohort, wherein the behavioral cohort reflects one or more end users. The method may further comprise sending, by the centralized server, the end user specific local model to the end user computing device. The method may further comprise deleting, by the end user computing device, one or more of the local assets based on the end user specific local model.

A web application asset management system is disclosed herein. The web application asset management system may comprise one or more processors. The web application asset management system may further comprise one or more non-transitory computer-readable storage devices storing computing instructions configured to run on the one or more processors and cause the one or more processors to perform: receiving, by an end user computing device, from a centralized server an asset package, wherein the asset package comprises one or more local assets; collecting, by the end user computing device, an end user data associated with a local application; receiving, by the centralized server, the end user data from the end user computing device; determining, by the centralized server, an end user specific local model based on a predictive classification model, the end user data, and a behavioral cohort, wherein the behavioral cohort reflects one or more end users; sending, by the centralized server, the end user specific local model to the end user computing device; and deleting, by the end user computing device, one or more of the local assets based on the 5 end user specific local model.

A web application asset management device is disclosed herein. The web application asset management device may comprise a non-transitory, tangible computer readable storage medium having instructions stored thereon that, in response to execution by a computer based system, cause the computer based system to perform operations comprising: receiving, by an end user computing device, from a centralized server an asset package, wherein the asset package comprises one or more local assets; collecting, by the end user computing device, end user data associated with a local application; receiving, by the centralized server, the end user data from the end user computing device; determining, by the centralized server, an end user specific local model based on a predictive classification model, the end user data, and a behavioral cohort, wherein the behavioral cohort reflects one or more end users; sending, by the centralized server, the end user specific local model to the end user computing device; and deleting, by the end user computing device, the one or more local assets based on the end user specific local model.

### BRIEF DESCRIPTION OF DRAWINGS

Additional aspects of the present disclosure will become evident upon reviewing the non-limiting embodiments described in the specification and the claims taken in conjunction with the accompanying figures, wherein like numerals designate like elements, and:

FIG. 1 illustrates a diagram of an exemplary web application asset management system, in accordance with various embodiments;

FIG. 2 illustrates a diagram of a centralized cloud-based application of a web application asset management system, in accordance with various embodiments;

FIG. 3 illustrates a diagram of an end user computing device equipped to implement a web application asset management system, in accordance with various embodiments;

FIG. 4 illustrates a flowchart of a various aspects of a method of web application asset management, in accordance with various embodiments; and

FIG. 5 illustrates a flowchart of a method of web application asset management, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values, and all ranges and ratio limits disclosed herein may be combined.

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

The disclosed embodiment relates generally to methods and systems for web application asset management. These web application asset management systems and methods may classify the probability of local assets being requested by users of PWAs.

Specifically, the method and system provides a means for collecting data from user devices and training classification models based on the collected end user data. The web application asset management system may distribute the classification models to end user computing devices to classify user assets based on historical user behavior and metadata. The web application asset management system may divide users into similar behavioral cohorts. For example, a behavioral cohort may be an organization of users and their associated user devices in particular sections. The web application asset management system may prioritize or provide user assets to user devices based on the behavioral cohort. Once deployed, the classification models may be used by the local application to keep or delete user assets from local user devices.

A benefit of this method and system is that user assets that have the highest priority of being accessed remain on the user device, while unneeded items are deleted. This optimizes storage and assists with ensuring that space is used for new user assets that may be needed by users. The web application asset management system allows users to access the local application while offline, and the application will be updated when the user is connected to the internet. In addition, this method and system also functions to solve a device-storage problem posed by downloading assets onto a device for offline use. Trained classification models inform the application to keep or delete user assets based on the priority of each asset and the likelihood that the user will need access to each asset while offline. By deleting user assets based on priority, the application preserves device storage while maintaining utility for the offline user.

For example, a teacher may require students' use of the application to provide homework and class materials for remote learning. When students are online at school, the local applications on the student devices are updated to provide assets to the user, such as video lectures and homework documents. These user assets may be downloaded onto the device to ensure that students can access these assets even if they do not have an internet connection at home. However, downloading assets can only be useful so long as the student device has adequate storage. Therefore, an example embodiment can delete assets off of the student device based on the priority of each asset and the likelihood that a student may open each asset, instead of traditional metrics such as file size or date downloaded. Furthermore, each class of students can be combined into a similar behavioral cohort to ensure that the assets kept or deleted off of each device are consistent throughout the class of students.

The systems and methods for web application asset management may predict which user assets should be kept locally on a user device versus a centralized server. The systems and methods for web application asset management decide which assets to keep and which assets to delete based on priority and the likelihood that a file will be needed among similar behavioral cohorts. Data collected on local applications on user devices is transmitted to a centralized server when a device is connected to the internet. The user data is used to create similar behavioral cohorts that represents similar types of users. The data from the behavioral cohort is collected to train predictive classification models that determine the probabilities of access and prioritization weights associated with a local asset. When deployed back to the user device, these classification models enable the local application to delete low-priority assets off the user device, while keeping a link to access the asset when connected to the internet. This solution ensures that high-priority assets are maintained on the user device to access without an internet connection, and low-priority assets are removed to optimize local storage on the user device.

In various embodiments, the local application may sync with the centralized server on a periodic basis, such as each week. Wherein the local application is in communication with the centralized server the local application may provide to the centralized server that a user asset has been deleted. The local application may provide periodic updates to the centralized server including user data, and the centralized server may continue to improve predictive classification models. In various embodiments, the local application may determine what user assets to keep or delete. In various embodiments, when a local application is connected to the internet, the local application may utilize an online version of a user asset, such as online streaming videos. However, when a local application is not connected to the internet, the local application may use a local version of a user asset, such a downloaded video file of a video, such as online streaming videos.

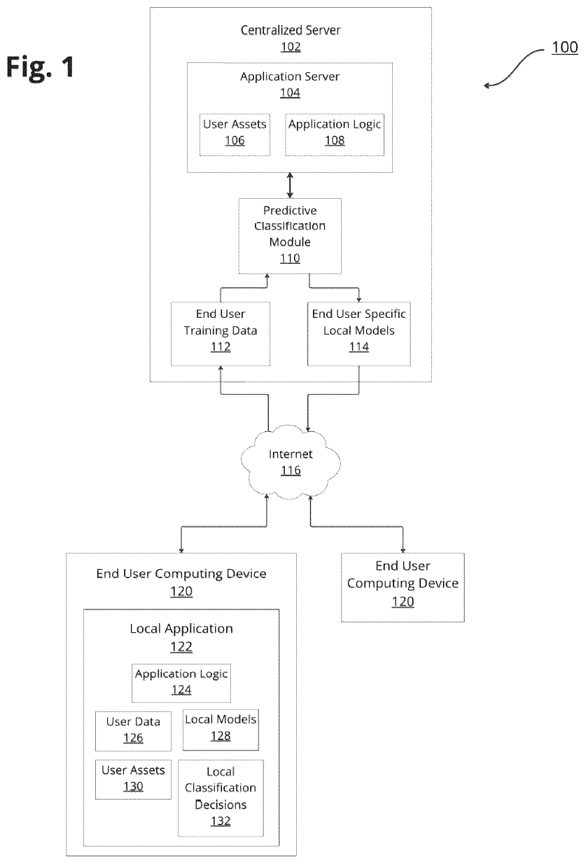

With reference to FIG. 1, a web application asset management system 100 is shown, in accordance with various embodiments. The web application asset management system 100 may comprise a centralized server 102 configured to connect with one or more end user computing devices 120. The end user computing device 120 comprises a local application 122. The local application 122 may further comprise application logic 124, user data 126, local models 128, user assets 130, and local classification decisions 132.

In various embodiments, the end user computing device 120 may host the local application 122. The local application 122 may be a progressive web application. For example, a progressive web application (PWA) may comprise a web app that may be installed on a device as a standalone application, while still providing the benefits of a website. The local application 122 may contain application logic 124 configured to periodically utilize local models 128 and perform deletion of local user assets 130 from the end user computing device 120. For example, the local application may determine which local assets to keep and/or delete on the end user computing device 120 based on the local models 128. The end user computing device 120 may determine whether to delete or keep user assets. In various embodiments, the local application 122 may determine which local asset to keep and/or delete when the end user computing device 120 is not connected to the internet. The local application 122 may collect user data 126. For example, the local application 122 may collect user data 126. The user data 126 may include, for example, files accessed by a user, time reviewed, file meta data, number of times accessed, device storage capacity, network details, session time, login history, device details, etc. The user data 126 may also be referred to herein as usage data. The local application 122 may also comprise user assets 130. The user assets 130 may include documents, video files, educational modules, etc. The local application 122 is further equipped with local models 128 that may determine which user assets 130 to keep or delete on the end user computing device 120.

The local models 128 may be informed by end user data and a predictive classification model specific to a behavioral cohort of end users, such as a class of students, for example. The local application 122 also consists of local classification decisions 132. The local models 128 can be used to generate local classification decisions 132. The local classification decisions 132 may be the result of model usage saved to the end user computing device 120 to perform file operations on the end user computing device 120.

A connection to the internet 116 represents a communication pathway between an end user computing device 120 and the centralized server 102. The end user computing device 120 may communicate with the centralized server 102 through the internet 116 when the end user computing device 120 obtains internet connection. The end user computing device 120 may communicate an asset package to the centralized server 102. The asset package may consist of user data 126 such as end user requests to access one or more local assets. The asset package may also consist of information on user assets 130 and file metadata such as file size, an asset identifier, and a file type, device storage capacity, network details, and session time.

The centralized server 102 receives this asset package and uses it as end user training data 112. Based on the end user training data 112, the centralized server 102 may place end users in one or more behavioral cohorts based on user data such as file requests, application usage, and historic end user usage data. The end user training data 112 for each behavioral cohort may inform predictive classification models 110.

The web application asset management system 100 may collect end user data from one or more end user computing devices 120, and train classification models based on the end user data, as described in more detail herein. Further, the web application asset management system 100 may distribute the classification models to end user computing devices. The end user computing device 120 may classify user assets based on historical end user usage data and may divide users into similar behavioral cohorts based on the historical end user usage data.

The predictive classification modules 110 may be configured to train predictive classification models and deploy the predictive classification models to the user devices. The predictive classification module 110 may be involved in the training, validation, and deployment of a prioritization weighting and a probability of access model based on the end user training data 112 the user assets 106 and the application logic 108. The end user training data 112 may be used by the predictive classification module 110 to train predictive classification models. The predictive classification module 110 may then develop a prioritization weighting and probability of access models for each behavioral cohort. The application server 104 may then validate this prioritization weighting and probability of access model using information such as user assets 106 and application logic 108. The application server 104 may return predictive classification model outputs to the predictive classification module 110. The predictive classification models 110 may then be deployed to each behavioral cohort to create end user specific local models 114. The end user specific local models 114 may be communicated over the internet 116. In various embodiments, the local model 128 may be received by the end user computing device 120 from the centralized server 102. The local model 128 may be based on the end user specific local models 114. The local model 128 may be similar in design and function as the end user specific local models 114 and these terms may be used interchangeably.

The end user specific local models 114 may provide a method for local applications 122 to make predictions about the likelihood specific user assets 106 may be accessed by specific end users. The end user specific local models 114 may inform the local application 122 of the prioritization weighting and probability of access model for the user assets 130. The local applications 122 may determine the probability the user asset 106 may be needed based on the end user specific local models 114, and determine whether to keep or delete a user asset 106 based on the end user specific local models 114. In some embodiments, the local application 122 may manage the versions of user assets 130 on the end user computing device 120. The local application 122 may also update the version of one or more user assets 130 on the end user computing device 120. For example, the local application 122 may delete one or more user assets 130 off of the end user computing device 120 and the local application 122 may replace the user assets 130 with a link to the asset that can be accessed via the internet.

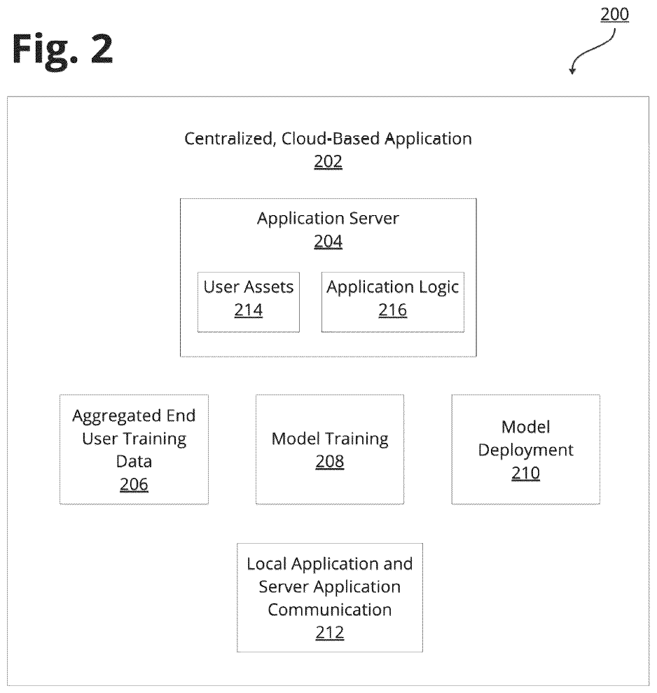

With reference now to FIG. 2, a diagram of a centralized cloud-based application of a web application asset management system 200 is shown, in accordance with various embodiments. The system 200 may comprise a centralized, cloud-based application 202 which may be similar in design and function to the centralized server 102, as discussed with reference to FIG. 1. The centralized, cloud-based application 202 may comprise an application server 204, aggregated end user training data 206, model training 208, model deployment 210, and/or local application and server application communication 212.

The application server 204 may be similar in design and function to application server 104. The application server 204 may comprise application logic 216 and be configured to store one or more user assets 214. The application server 204 may also utilize the aggregated end user training data 206 to periodically create the predictive classification models by the model training 208. The predictive classification models may develop a prioritization weighting and a probability of access model for each asset package. The application server 204 may validate this prioritization weighting and probability of access model. The application server 204 may use information on user assets 214 and application logic 216 to validate the prioritization weighting and probability of access models for each behavioral cohort.

In various embodiments of the centralized, cloud-based application 202, may comprise aggregated end user training data 206. The aggregated end user training data 206 may comprise an aggregation of end user data, user asset information and/or asset packages. The centralized, cloud-based application 202 may place end users in one or more behavioral cohorts based on the aggregated end user training data 206.

The model training 208 may train predictive models based on aggregated end user training data 206. In various embodiments, the model training 208 may train the predictive model based on a specific behavioral cohort.

The centralized, cloud-based application may comprise model deployment 210. The model deployment 210 may “deploy” or send the predictive model to an end user device. For example, the model training 208 may be configured to train a model based on the aggregated end user training data 206. The model deployment 210 may provide the model to specific users of the respective behavioral cohort of users whose data trained the predictive model.

The centralized, cloud-based application 202 may comprise a local application communication and server application communication 212. The local application and server application communication 212 may enable the centralized, cloud-based application 202 to send and receive information from the application server 204 and the end user computing device 120, as described with reference to FIG. 1. The centralized, cloud-based application 202 may receive an asset package from one or more end user computing devices.

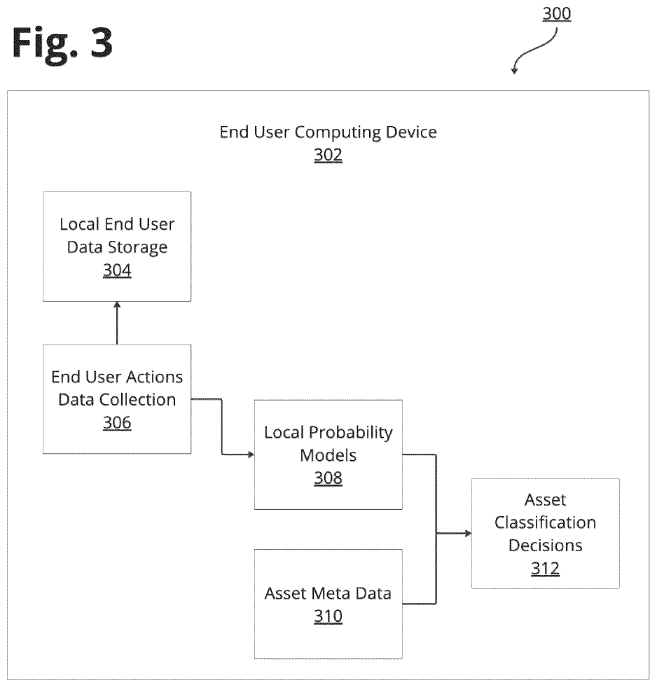

With reference now to FIG. 3, an end user computing device 302 of a web application asset management system 300 is shown, in accordance with various embodiments. The end user computing device 302 may be similar in design and function to end user computing device 120. The end user computing device 302 may comprise local end user data storage 304, functionality to provide end user actions data collection 306, local probability models 308, asset metadata 310, and/or one or more asset classification decisions 312.

The end user computing device 302 provides end user actions data collection 306 configured to collect end user data. The end user data collected may include files accessed by the end user, end user requests to access files, time reviewed, file metadata, device storage capacity, network details, session time, etc. In various embodiments, this collection of data can inform probabilities of access for each local asset for each end user. The end user computing device 302 may also collect information about the local end user data storage 304 available on the device. This information may be used to create prioritization weights for local assets on the end user computing device 302 based on file size and type and available local end user data storage 304.

In some embodiments, end user actions data collection 306 and local end user data storage 304 may inform local probability models 308. Specifically, the end user specific local probability models 308 may be informed by probabilities of access for local assets and/or prioritization weights associated with local assets, in various embodiments.

The data collected by the end user computing device 302 is used by local probability models 308 to make predictions about the likelihood a local asset will be accessed by the user in some embodiments. Local user data and local user actions provide reinforcement learning for local probability models 308 in order to optimize predictions and classification. Local probability models 308 may be combined with asset metadata 310 to inform asset classification decisions 312. Asset metadata may consist of information about local specific local assets, such as file size, an asset identifier, and/or a file type.

In some embodiments, asset classification decisions 312 on local models use asset attributes like file size to prioritize the relative value of having an asset present on the local system versus only available from the server over the network. These asset classification decisions 312, when combined with probabilities of access for local assets and/or prioritization weights associated with local assets, can enable the local application to prioritize which assets should be kept locally versus which assets can be left on the server for access over the network.

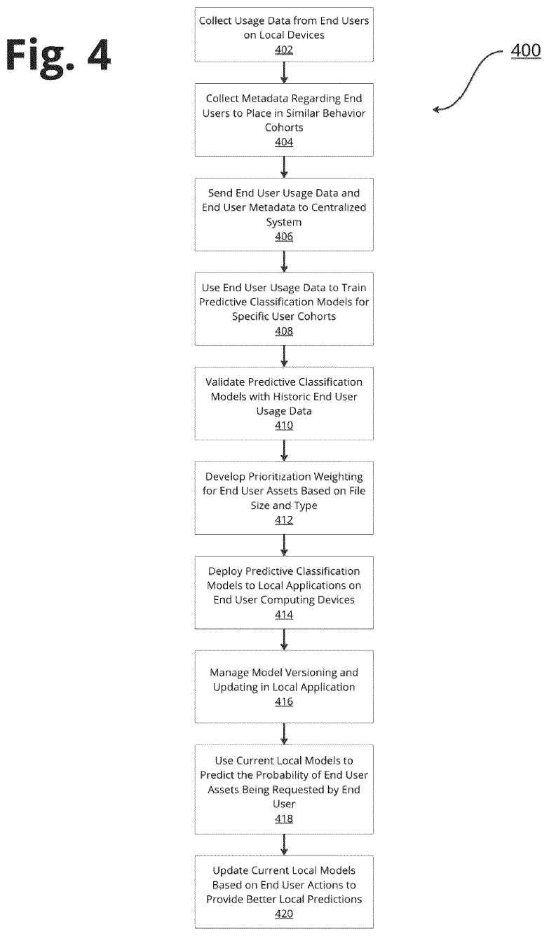

With reference to FIG. 4, a flowchart of a method of web application asset management 400 is shown, in accordance with various embodiments. In various embodiments, an end user computing device may collect usage data from end users on local devices, such as end user computing devices (step 402). The usage data may include requests for user assets, historic usage data, device storage capacity, network details, and session time, etc. An end user computing device may also collect metadata regarding end users to place in similar behavior cohorts (step 404). The metadata may include file size, an asset identifier, file type, and file grouping/hierarchy information.

An end user computing device may then send end user usage data and end user metadata to a centralized system (step 406). In some embodiments, the end user computing device sends end user usage data and end user metadata to a centralized system over an internet connection.

In some embodiments, a centralized, cloud-based server may receive end user usage data and end user metadata over the internet. Based on the aggregated user data from each end user computing device, the centralized server may place end users into similar behavioral cohorts.

The centralized server may also use end user usage data and end user metadata to train predictive classification models for specific behavioral cohorts for example (step 408). For each behavioral cohort, the centralized server may also validate predictive classification models with historic end user usage data (step 410).

A centralized server may further develop prioritization weighting for end user assets based on file size and type (step 412). A centralized server may also deploy predictive classification models to local applications on end user computing devices for each behavioral cohort (step 414).

The predictive classification models may allow end user computing devices to manage model versioning and updating in the local application (step 416). The local application may also update the version of one or more user assets on the end user computing device. In doing so, the local application may delete one or more user assets off of the end user computing device. In some embodiments, the local application may replace the user assets with a link to the asset that can be accessed via the internet.

In some embodiments, an end user computing device may use current local models to predict the probability of end user assets being requested by end user (step 418). An end user computing device may further update current local models based on end user actions to provide better local predictions (step 420). Using this system, the local application can continuously learn from user actions and adjust which files are kept locally and remotely and thereby make optimal use of the local storage the local application has access to. This will enable the user to have the files they need locally when they are offline and not connected to the internet. It will also provide better performance for users in degraded network environments by intelligently caching the local files most likely to be used and thereby eliminating the time and bandwidth required to request those assets over the degraded network.

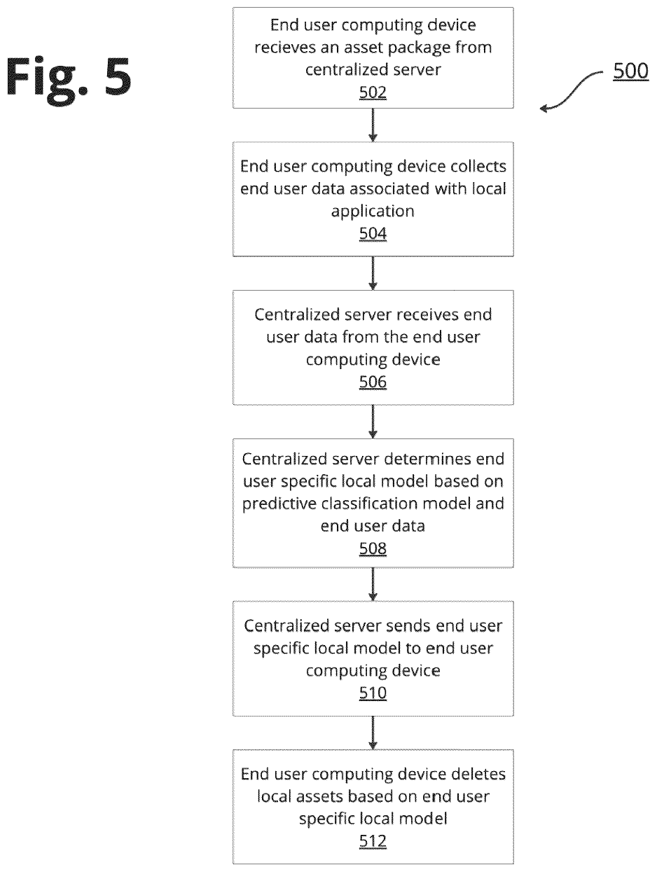

With reference to FIG. 5, a flowchart of a method of web application asset management 500 is shown, in accordance with various embodiments. In various embodiments, an end user computing device may receive an asset package from a centralized server (step 502). This asset package may consist of application logic to conduct updates and version management on the local application, as well as files to download on the end user computing device. The end user computing device may then collect end user data associated with the local application (step 504). In various embodiments, the end user data may include usage data such as requests for assets, historic usage data, device storage capacity, network details, session time, etc., as well as metadata such as file size, an asset identifier, file type, and file grouping/hierarchy information.

In various embodiments, the end user computing device may send this data to a centralized server (step 506). Based on the end user data from each end user computing device, the centralized server may place end users into similar behavioral cohorts. The centralized server may also use end user data to train predictive classification models for specific behavioral cohorts (step 508). A centralized server may further develop prioritization weighting for end user assets based on file size and type.

A centralized server may also send end user specific local models to end user computing devices (step 510). The end user specific predictive classification models may allow end user computing devices to manage model versioning and updating in the local application. The local application may also update the version of one or more user assets on the end user computing device. In doing so, the local application may delete one or more user assets off the end user computing device. In some embodiments, the local application may replace the user assets with a link to the asset that can be accessed via the internet.

In various embodiments, the modules discussed herein can be implemented as and may include one or more processors and/or one or more tangible, non-transitory memories (e.g., memory) and be capable of implementing logic. Each processor can be a general-purpose processor, a digital signal processor (“DSP”), an application specific integrated circuit (“ASIC”), a field programmable gate array (“FPGA”), or other programmable logic device, discrete gate or transistor logic, discrete hardware components, or any combination thereof. The controller can comprise a processor configured to implement various logical operations in response to execution of instructions, for example, instructions stored on a non-transitory, tangible, computer-readable medium configured to communicate with the modules discussed.

System program instructions and/or controller instructions can be loaded onto a non-transitory, tangible computer-readable medium of the modules having instructions stored thereon that, in response to execution by a processor of the modules, cause the modules to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc. indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed is:

1. A method for web application asset management, comprising:
receiving, by an end user computing device, from a centralized server an asset package, wherein the asset package comprises one or more local assets;
collecting, by the end user computing device, an end user data associated with a local application;
receiving, by the centralized server, the end user data from the end user computing device;
determining, by the centralized server, an end user specific local model based on a predictive classification model, the end user data, and a behavioral cohort, wherein the behavioral cohort reflects one or more end users;
sending, by the centralized server, the end user specific local model to the end user computing device; and
deleting, by the end user computing device, one or more of the local assets based on the end user specific local model.

2. The method of claim 1, further comprising:
collecting, by the end user computing device, a metadata based on the local assets,
wherein the metadata comprises a file size, an asset identifier, and a file type; and
wherein the end user data comprises the metadata.

3. The method of claim 1, further comprising:
receiving, by the end user computing device, an end user request, wherein the end user request comprises a request to access the one or more local assets; and
storing, by the end user computing device, the end user request.

4. The method of claim 1, further comprising:
determining, by the centralized server, the one or more end user specific local models is further based on a behavioral cohort, wherein the behavioral cohort reflects one or more end users;
placing, by the centralized server, the one or more end users in one or more behavioral cohorts based on the end user specific local model, wherein the one or more end users each comprise the end user computing device.

5. The method of claim 3, further comprising:
validating, by the centralized server, the predictive classification model based on a historic end user usage data, wherein the historic end user usage data comprises the end user request.

6. The method of claim 2, further comprising:
developing, by the centralized server, a prioritization weighting and a probability of access model for the asset package based on the metadata.

7. The method of claim 1, further comprising:
managing, by the end user computing device, a version of the end user specific local model; and
updating, by the end user computing device, the version of the end user specific local model, wherein the end user specific local model comprises one or more probabilities of access and one or more prioritization weights associated with the local assets.

8. The method of claim 1, wherein the one or more local assets are stored in a browser local storage.

9. The method of claim 1, further comprising linking to a deleted local asset through a logical reference based on the end user specific local model.

10. A web application asset management system comprising:
one or more processors; and
one or more non-transitory computer-readable storage devices storing computing instructions configured to run on the one or more processors and cause the one or more processors to perform:
receiving, by an end user computing device, from a centralized server an asset package, wherein the asset package comprises one or more local assets;
collecting, by the end user computing device, an end user data associated with a local application;
receiving, by the centralized server, the end user data from the end user computing device;
determining, by the centralized server, an end user specific local model based on a predictive classification model, the end user data, and a behavioral cohort, wherein the behavioral cohort reflects one or more end users;
sending, by the centralized server, the end user specific local model to the end user computing device; and
deleting, by the end user computing device, one or more of the local assets based on the end user specific local model.

11. The system of claim 10, wherein the operations further comprise:
collecting, by the end user computing device, a metadata based on the local assets,
wherein the metadata comprises a file size, an asset identifier, and a file type; and
wherein the end user data comprises the metadata.

12. The system of claim 10, wherein the operations further comprise:
receiving, by the end user computing device, an end user request, wherein the end user request comprises a request to access the one or more local assets; and
storing, by the end user computing device, the end user request.

13. The system of claim 10, wherein the operations further comprise:
determining, by the centralized server, the one or more end user specific local models is further based on a behavioral cohort, wherein the behavioral cohort reflects one or more end users; and
placing, by the centralized server, the one or more end users in one or more behavioral cohorts based on the end user specific local model, wherein the one or more end users each comprise the end user computing device.

14. The system of claim 12, wherein the operations further comprise:
validating, by the centralized server, the predictive classification model based on a historic end user usage data, wherein the historic end user usage data comprises the end user request.

15. The system of claim 11, wherein the operations further comprise:
developing, by the centralized server, a prioritization weighting and a probability of access model for the asset package based on the metadata.

16. The system of claim 10, wherein the operations further comprise:
managing, by the end user computing device, a version of the end user specific local model; and
updating, by the end user computing device, the version of the end user specific local model, wherein the end user specific local model comprises one or more probabilities of access and one or more prioritization weights associated with the local assets.

17. The system of claim 10, wherein the operations further comprise storing the one or more local assets in a browser local storage.

18. The system of claim 10, wherein the operations further comprise linking to a deleted local asset through a logical reference based on the end user specific local model.

19. A web application asset management device comprising a non-transitory, tangible computer readable storage medium having instructions stored thereon that, in response to execution by a computer based system, cause the computer based system to perform operations comprising:
receiving, by an end user computing device, from a centralized server an asset package, wherein the asset package comprises one or more local assets;
collecting, by the end user computing device, end user data associated with a local application;
receiving, by the centralized server, the end user data from the end user computing device;
determining, by the centralized server, an end user specific local model based on a predictive classification model, the end user data, and a behavioral cohort, wherein the behavioral cohort reflects one or more end users;
sending, by the centralized server, the end user specific local model to the end user computing device; and
deleting, by the end user computing device, the one or more local assets based on the end user specific local model.

20. The device of claim 19, wherein the operations further comprise:
collecting, by the end user computing device, a metadata based on the local assets,
wherein the metadata comprises a file size, an asset identifier, and a file type; and
wherein the end user data comprises the metadata.
